(19) United States
(12) Patent Application Publication
(10) Pub. No.: US 2026/0277238 A1
(43) Pub. Date: Sep. 17, 2026

(54) SYSTEM AND METHOD OF ADAPTIVE MOTOR CONTROL FOR AUTONOMOUS MOBILE ROBOTS FOR VARYING PAYLOADS

(71) Applicant: GM Global Technology Operations LLC, Detroit, MI (US)

(72) Inventors: Yubiao Zhang, Troy, MI (US); Chen Chen, Troy, MI (US); Jesse Heidrich, Shelby Township, MI (US); Joshua Lee Solomon, Berkley, MI (US)

(73) Assignee: GM Global Technology Operations LLC, Detroit, MI (US)

(21) Appl. No.: 19/078,135

(22) Filed: Mar. 12, 2025

(51) Int. Cl. G05D 1/65; G05D 1/667; G05D 101/15; G05D 105/20; G05D 109/10

(52) U.S. Cl. CPC G05D 1/65; G05D 1/667; G05D 2101/15; G05D 2105/20; G05D 2109/10

(57) ABSTRACT

A method includes detecting, in real time, that a vehicle transporting a product is at a nominal speed. In response to detecting that the vehicle is at the nominal speed, the method also includes receiving propulsion data from a propulsion system of the vehicle, based on the propulsion data, predicting, using a payload estimation model, a payload estimation of the product transported by the vehicle, and determining whether the payload estimation meets an estimation threshold. When the payload estimation exceeds the estimation threshold, the method also includes dynamically adjusting controller gains of the propulsion system to optimize the propulsion system for the payload estimation.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a system and method of adaptive motor control for autonomous mobile robots (AMRs) for varying payloads. AMRs are sophisticated machines designed to navigate and perform tasks in various environments without human intervention. These robots utilize a combination of sensors, cameras, and advanced algorithms to perceive their surroundings, make decisions, and move efficiently. AMRs are commonly employed in industries such as manufacturing, warehousing, healthcare, and logistics, where they enhance productivity by automating repetitive tasks, transporting goods, and assisting with inventory management.

Current AMR systems often incorporate load cell sensors positioned at the corners of the robots. These sensors are crucial for detecting and measuring the weight of payloads, ensuring stability and safety during transportation. However, implementing load cell sensors can be complex due to the need for precise calibration and integration with the robot's control systems. Additionally, AMRs are often expected to handle a wide range of payloads, ranging from zero (0) to 1500 pounds, which necessitates adaptable sensor systems to maintain performance and reliability across different applications. As such, providing lightweight sensors while compensating for the varying payloads may allow improved performance of the AMRs.

### SUMMARY

One aspect of the disclosure provides a computer-implemented method of adaptive motor control for autonomous mobile robots (AMRs) for varying payloads that when executed on data processing hardware causes the data processing hardware to perform operations that include detecting, in real time, that a vehicle transporting a product is at a nominal speed. In response to detecting that the vehicle is at the nominal speed, the operations also include receiving propulsion data from a propulsion system of the vehicle, based on the propulsion data, predicting, using a payload estimation model, a payload estimation of the product transported by the vehicle, and determining whether the payload estimation meets an estimation threshold. When the payload estimation exceeds the estimation threshold, the operations further include dynamically adjusting controller gains of the propulsion system to optimize the propulsion system for the payload estimation.

Implementations of the disclosure may include one or more of the following optional features. In some implementations, the propulsion data includes one or more of current, speed, or torque. In some examples, the payload estimation model is pre-trained in an offline training process. In these examples, the offline training process may pre-train the payload estimation model to predict a payload given an input of propulsion data.

In some implementations, the operations further include receiving a center of gravity of the vehicle transporting the product. In these implementations, dynamically adjusting the controller gains of the propulsion system to optimize the propulsion system for the payload estimation may further include adapting constraints of the propulsion system based on the center of gravity of the vehicle transporting the product. The constraints of the propulsion system may include one or more of acceleration, deceleration, or maximum speed. In some examples, the operations further include, when the payload estimation does not exceed the estimation threshold, adjusting the controller gains of the propulsion system using nominal gains. In some implementations, detecting, in real time, that the vehicle transporting the product is at the nominal speed includes measuring the propulsion data at one of startup or acceleration of the propulsion system.

Another aspect of the disclosure provides a system of adaptive motor control for AMRs for varying payloads that includes data processing hardware and memory hardware in communication with the data processing hardware. The memory hardware stores instructions that when executed by the data processing hardware cause the data processing hardware to perform operations that include detecting, in real time, that a vehicle transporting a product is at a nominal speed. In response to detecting that the vehicle is at the nominal speed, the operations also include receiving propulsion data from a propulsion system of the vehicle, based on the propulsion data, predicting, using a payload estimation model, a payload estimation of the product transported by the vehicle, and determining whether the payload estimation meets an estimation threshold. When the payload estimation exceeds the estimation threshold, the operations further include dynamically adjusting controller gains of the propulsion system to optimize the propulsion system for the payload estimation.

This aspect may include one or more of the following optional features. In some implementations, the propulsion data includes one or more of current, speed, or torque. In some examples, the payload estimation model is pre-trained in an offline training process. In these examples, the offline training process may pre-train the payload estimation model to predict a payload given an input of propulsion data.

In some implementations, the operations further include receiving a center of gravity of the vehicle transporting the product. In these implementations, dynamically adjusting the controller gains of the propulsion system to optimize the propulsion system for the payload estimation may further include adapting constraints of the propulsion system based on the center of gravity of the vehicle transporting the product. The constraints of the propulsion system may include one or more of acceleration, deceleration, or maximum speed. In some examples, the operations further include, when the payload estimation does not exceed the estimation threshold, adjusting the controller gains of the propulsion system using nominal gains. In some implementations, detecting, in real time, that the vehicle transporting the product is at the nominal speed includes measuring the propulsion data at one of startup or acceleration of the propulsion system.

Another aspect of the disclosure provides a computer-implemented method of adaptive motor control for AMRs for varying payloads that when executed on data processing hardware causes the data processing hardware to perform operations that include detecting, in real time, that a propulsion system transporting a product is at a nominal speed. In response to detecting that the propulsion system is at the nominal speed, the operations further include predicting, using a payload estimation model, a payload estimation of the product, and when the payload estimation exceeds an estimation threshold, dynamically adjusting controller gains of the propulsion system to optimize the propulsion system for the product.

This aspect may include one or more of the following optional features. In some implementations, dynamically adjusting the controller gains of the propulsion system to optimize the propulsion system for the product further includes adapting constraints of the propulsion system based on a center of gravity of the product.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system of adaptive motor control for autonomous mobile robots (AMRs) for varying payloads.

FIG. 2 is a schematic view of example components of the system of FIG. 1.

FIGS. 3A and 3B are schematic views of AMRs transporting varying payloads.

FIG. 4 is a flowchart of an example arrangement of operations for a method of adaptive motor control for AMRs for varying payloads.

FIG. 5 is another flowchart of an example arrangement of operations for a method of adaptive motor control for AMRs for varying payloads.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

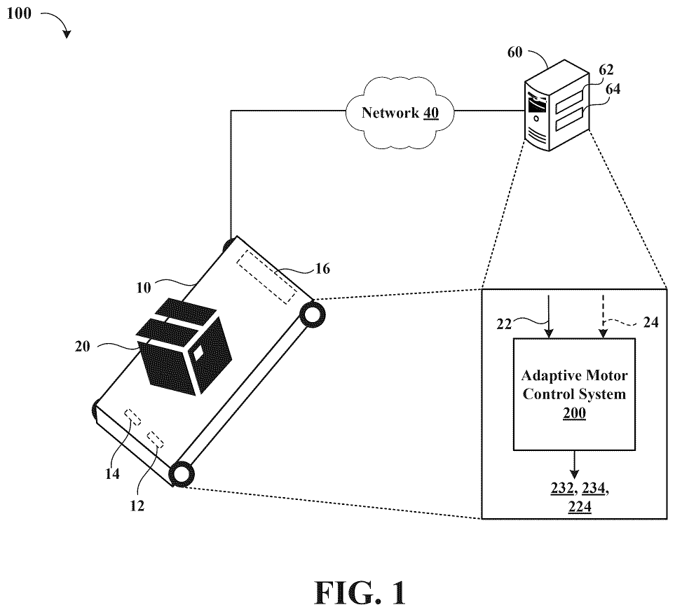

Referring to FIG. 1, in some implementations, a system 100 includes a vehicle 10 transporting a product 20 and in communication with a remote system 60 via a network 40 (e.g., wired or wireless communication). In the example shown, the vehicle 10 is implemented as an autonomous mobile robot (AMR), however, it should be understood that the vehicle 10 may be implemented as any other propulsion system, such as, without limitation, motor vehicles, motorcycles, trucks, off-road vehicles, farm equipment, trains, aircraft, and the like. The vehicle 10 and/or the remote system 60 execute an adaptive motor control system 200 configured to dynamically adjust control gains 232 of the vehicle 10 to adapt to the varying payloads of products 20 transported by the vehicle 10 based on real-time outputs of a propulsion system 16 of the vehicle 10. As used herein, the controller gains 232 may optimize the propulsion system 16 to ensure smooth operation of the vehicle 10 even with large variations in the payload and maintain the stability of the vehicle 10 and/or the product 20. As described in greater detail below, rather than relying on load cell sensors that are traditionally mounted on the corners of the vehicle 10 and are often costly and complex to implement, the adaptive motor control system 200 relies on existing propulsion data 22 measured by the propulsion system 16 of the vehicle 10 when moving varying payloads (e.g., ranging from zero (0) to 1500 pounds). Notably, these traditional propulsion systems further rely on fixed control gains, which require additional calibration as payloads change, whereas the adaptive motor control system 200 performs real-time adaptations to the control gains of the propulsion system 16, allowing the vehicle 10 to vary its parameters and constraints on-the-fly.

As shown in FIG. 1, the vehicle 10 includes data processing hardware 12 and memory hardware 14 storing instructions that when executed on the data processing hardware 12 cause the data processing hardware 14 to perform operations. The vehicle 10 further includes the propulsion system 16 configured to move the vehicle 10. The propulsion system 16 may capture/measure propulsion data 22 of the vehicle 10 as the vehicle 10 moves. For instance, the propulsion data 22 may include one or more of a current of the propulsion system 16, a speed of the propulsion system 16, or a torque of the propulsion system 16. While the adaptive motor control system 200 is shown as executing on the vehicle 10 and/or the remote system 60, the adaptive motor control system 200 can be implemented on other computing devices (e.g., computing devices in communication with the vehicle 10), such as, without limitation, a smart phone, tablet, smart display, desktop/laptop, smart watch, smart appliance, or smart glasses/headset.

The network 40 may include a wireless local area network (WLAN) that facilitates communication and interoperability between the vehicle 10 and the remote system 60 within an environment of the vehicle 10. Thus, the network 40 can include Wireless Fidelity (WiFi®) (e.g., IEEE 802.11), Low-Rate Wireless Personal Area Networks (e.g., IEEE 802.15.4), worldwide interoperability for microwave access (WiMAX®), 3G, 4G, Long Term Evolution (LTE®), 5G, digital subscriber line (DSL), Bluetooth®, Near Field Communication (NFC), or any other wireless standards, or Ethernet (e.g., IEEE 802.3). The system 100 may additionally include one or more access points (AP) (not shown) configured to facilitate wireless communication between the vehicle 10 and the remote system 60.

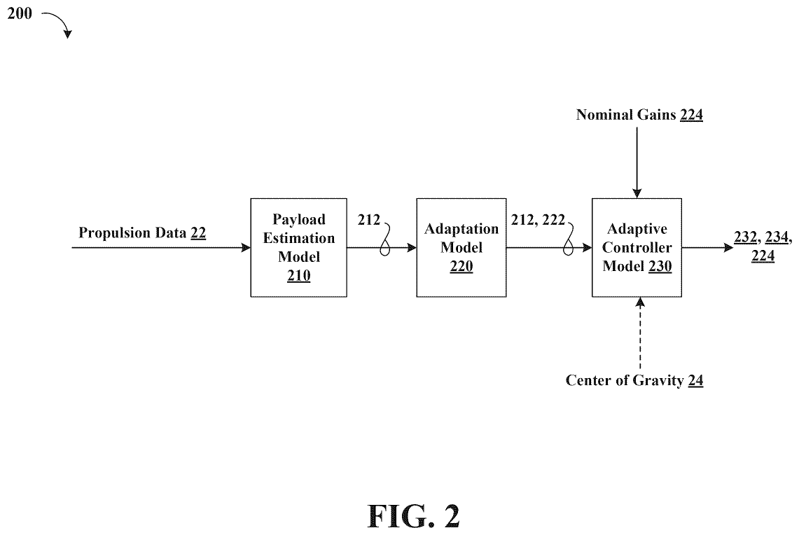

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the adaptive motor control system 200 is shared across the vehicle 10 and the remote system 60. As shown in FIGS. 1 and 2, the adaptive motor control system 200 executes a payload estimation model 210, an adaptation model 220, and an adaptive controller model 230. While the vehicle 10 is moving, the adaptive motor control system 200 may continually receive the propulsion data 22 measured by the propulsion system 16 and detect whether the vehicle 10 is at a nominal speed. As used herein, the nominal speed may refer to startup or acceleration of the propulsion system 16. When the adaptive motor control system 200 detects, in real time, that the vehicle 10 is at the nominal speed, it may provide the propulsion data 22 as input to the payload estimation model 210. The payload estimation model 210 is configured to receive the propulsion data 22 from the propulsion system 16 and predict, based on the propulsion data 22, an estimated payload 212 of a product 20 transported by the vehicle 10. In some instances, the payload estimation model 210 uses two (2) seconds of propulsion data 22 (e.g., acceleration) to estimate the payload 212 using a least squares regression.

The payload estimation model 210 may be pre-trained in an offline training process. For instance, the payload estimation model 210 may be pre-trained using collected propulsion data paired with varied known payloads. The offline training process may execute on the remote system 60 of FIG. 1. Here, the offline training process may train the payload estimation model 210 to predict a payload 212 given an input of propulsion data. In some instances, the payload estimation model 210 includes an end-to-end (E2E) neural network trained to predict a payload 212 based on the given set of inputs of propulsion data 22. In other instances, the payload estimation model 210 includes a lookup table derived from the relationship between known payloads 212 and corresponding propulsion data 22.

With continued reference to FIGS. 1 and 2, the adaptation model 220 receives, as input, the estimated payload 212 predicted by the payload estimation model 210 and determines whether the estimated payload 212 meets an estimation threshold necessitating an adjustment of the controller gains 232 of the propulsion system 16. Here, the estimation threshold may be based on a confidence level that the estimated payload 212 necessitates an adjustment of the controller gains 232 of the propulsion system 16. For instance, the adaptation model 220 may determine an estimation confidence 222 (e.g., a variance or standard deviation of the payload estimation 212) of the estimated payload 212 and, when the estimation confidence 222 is above the estimation threshold, it may indicate that the controller gains 232 should be adjusted (i.e., by the adaptive controller model 230) to account for the estimated payload 212 of the product 20. Conversely, when the adaptation model 220 determines that the estimation confidence 222 of the estimated payload 212 does not exceed the estimation threshold, the adaptation model 220 may prompt the adaptive motor controller model 230 to use the nominal gains 224 to adjust the controller gains 232.

In other implementations, the adaptation model 220 may employ a convergence speed to determine whether the estimated payload 212 meets the estimation threshold. Here, when the adaptation model 220 determines that the estimated payload 212 converges within an acceptable time frame (e.g., one (1) to two (2) seconds), it may use the adjusted controller gains 232 of the propulsion system. In contrast, when the adaptation model 220 determines that the estimated payload 212 does not converge within the acceptable time frame, the adaptation model 220 may prompt the adaptive motor controller model 230 to use the nominal gains 224 to adjust the controller gains 232. In other implementations, the adaptation model 220 may monitor the fluctuations in consecutive estimated payloads 212 to determine whether the payload estimate 212 exceeds the estimation threshold. In these implementations, the adaptation model 220 may trigger the adaptive motor controller to dynamically adjust the controller gains 232 when the payload estimate 212 fluctuates significantly from the previous payload estimates 212. Whereas the adaptation model 220 may prompt the adaptive motor controller model 230 to use the nominal gains 224 to adjust the controller gains 232 when the payload estimate 212 indicates a steady state of the product 20 (i.e., the product 20 and corresponding payload have not changed).

The adaptive motor controller model 230 receives, as input, the payload estimate 212 and the estimation confidence 222 determined by the adaptation model 220 and adjusts the gains of the propulsion system 16 based on the payload estimate and the estimation confidence 222. Here, the gains may include the proportional gains (p-gains) and integral gains (i-gains) of a proportional-integral-derivative (PID) controller of the propulsion system 16. In other words, based on the estimation confidence 222 (i.e., the estimation confidence 222 exceeding the estimation threshold) determined by the adaptation model 220, the adaptive motor controller 230 dynamically adjusts the controller gains 232 to optimize the propulsion system 16 of the vehicle 10 for the estimated payload 212. Whereas, when the estimation confidence 222 does not exceed the estimation threshold, the adaptive motor controller 230 may adjust the gains using nominal gains 224 of the propulsion system 16. Here, the nominal gains 224 may include a pre-calibrated gain schedule for different payloads that is stored on the memory hardware (14, 64) of the system 100. In some instances, the adaptive motor controller 230 includes an end-to-end (E2E) neural network trained to generate the optimized gains for the propulsion system 16 based on a given estimated payload 212. In other instances, the adaptive motor controller 230 includes a pre-calibrated lookup table derived from the relationship between schedule gains 232 and estimated payloads 212 for optimizing the gains given the estimated payload 212.

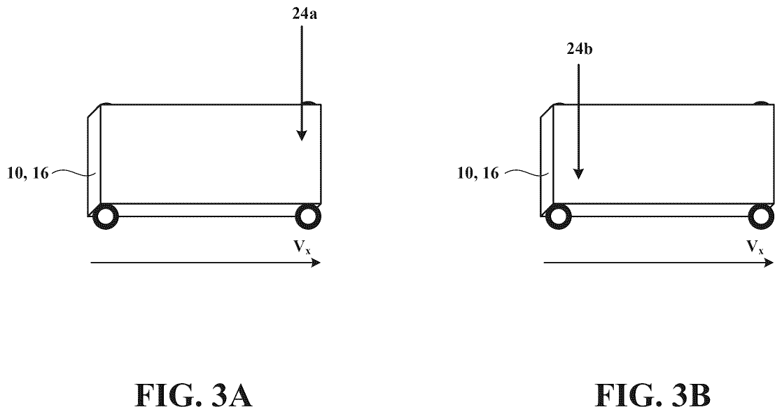

With reference to FIGS. 2-3B, the adaptive motor controller 230 may further receive, as input, a center of gravity 24 of the vehicle 10 transporting the product 20. Intuitively, the product 20 may be placed in any location of the vehicle 10, and the density of the product 20 may not be uniform. Therefore, the center of gravity 24 of the vehicle 10 may change based on the particular product 20 and its placement on the vehicle 10. Optionally, the center of gravity 24 may be measured by a load sensor of the vehicle 10. In other implementations, the center of gravity 24 may be derived from the propulsion data 22 measured over a given window of time sufficient to estimate the center of gravity 24 of the vehicle 10. In these instances where the adaptive motor controller 230 receives the center of gravity 24, the adaptive motor controller 230 may dynamically adjust the controller gains 232 of the propulsion system 16 to optimize the propulsion system 16 for the payload estimation 212 by adapting constraints 234 of the propulsion system 16 based on the center of gravity 24. The constraints 234 of the propulsion system 16 may include one or more of the acceleration of the propulsion system 16, the deceleration of the propulsion system 16, or the maximum speed of the propulsion system 16.

As shown in FIG. 3A, the center of gravity 24a is shown adjacent to the front left of the vehicle 10 as the propulsion system 16 moves the vehicle 10 along the trajectory Vₓ. Given this particular center of gravity 24a, the adaptive motor controller 230 may adjust the constraints 234 of the propulsion system 16 by decreasing the deceleration limit and the maximum speed. With particular reference to FIG. 3B, the center of gravity 24b is now shown adjacent to the rear right of the vehicle 10 as the propulsion system 16 moves the vehicle 10 along the trajectory Vₓ. Here, when the adaptive motor controller 230 receives this center of gravity 24b, it may adjust the constraints 234 of the propulsion system 16 by decreasing the acceleration limit and the maximum speed.

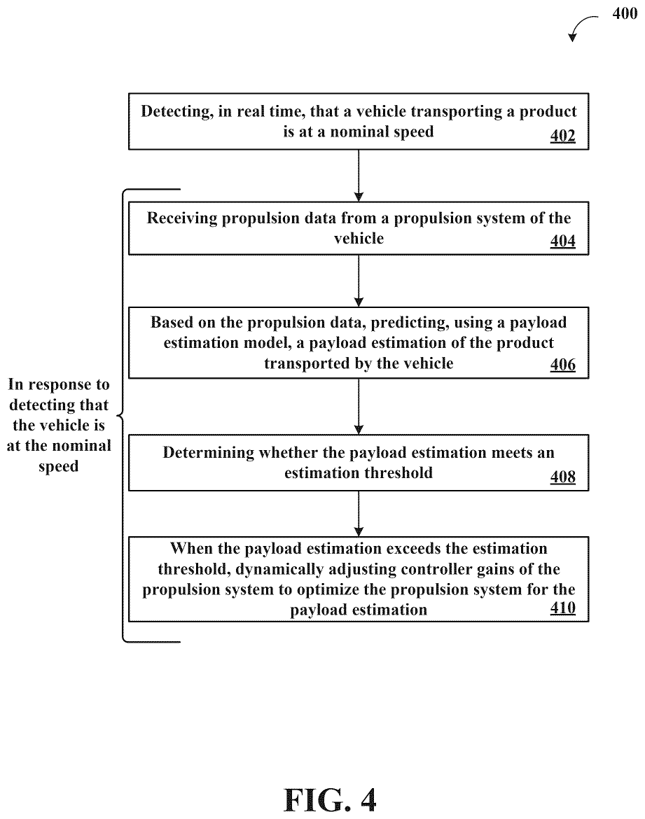

FIG. 4 includes a flowchart of an example arrangement of operations for a method 400 of adaptive motor control for autonomous mobile robots (AMRs) for varying payloads. The method 400 may be described with reference to FIGS. 1-3B. Data processing hardware (e.g., data processing hardware 12, 62 of FIG. 1) may execute instructions stored on memory hardware (e.g., memory hardware 14, 64 of FIG. 1) to perform the example arrangement of operations for the method 400. At operation 402, the method 400 includes detecting, in real time, that a vehicle 10 transporting a product 20 is at a nominal speed.

In response to detecting that the vehicle 10 is at the nominal speed, the operations 404-410 are performed. At operation 404, the method 400 includes receiving propulsion data 22 from a propulsion system 16 of the vehicle 10. Based on the propulsion data 22, at operation 406, the method 400 also includes predicting, using a payload estimation model 210, a payload estimation 212 of the product 20 transported by the vehicle 10. The method 400 further includes, at operation 408, determining whether the payload estimation 212 meets an estimation threshold. When the payload estimation 212 exceeds the estimation threshold, the method 400 also includes, at operation 410, dynamically adjusting controller gains 232 of the propulsion system 16 to optimize the propulsion system 16 for the payload estimation 212.

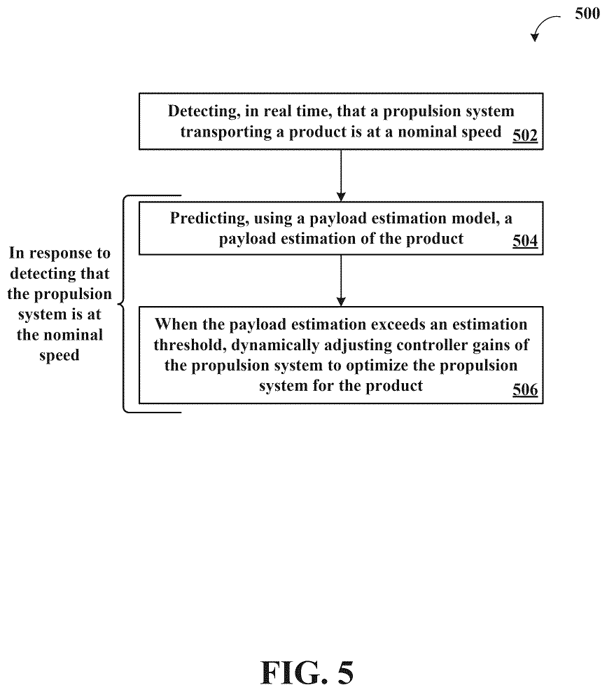

FIG. 5 includes a flowchart of an example arrangement of operations for a method 500 of adaptive motor control for AMRs for varying payloads. The method 500 may be described with reference to FIGS. 1-3B. Data processing hardware (e.g., data processing hardware 12, 62 of FIG. 1) may execute instructions stored on memory hardware (e.g., memory hardware 14, 64 of FIG. 1) to perform the example arrangement of operations for the method 500. At operation 502, the method 500 includes detecting, in real time, that a propulsion system 16 transporting a product 20 is at a nominal speed.

In response to detecting that the propulsion system 16 is at the nominal speed, the operations 504 and 506 are performed. At operation 504, the method 500 also includes predicting, using a payload estimation model 210, a payload estimation 212 of the product 20. When the payload estimation 212 exceeds an estimation threshold, the method 500 further includes, at operation 506, dynamically adjusting controller gains 232 of the propulsion system 16 to optimize the propulsion system 16 for the product 20.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method executing on data processing hardware that causes the data processing hardware to perform operations comprising:
detecting, in real time, that a vehicle transporting a product is at a nominal speed;
in response to detecting that the vehicle is at the nominal speed:
receiving propulsion data from a propulsion system of the vehicle;
based on the propulsion data, predicting, using a payload estimation model, a payload estimation of the product transported by the vehicle;
determining whether the payload estimation meets an estimation threshold; and
when the payload estimation exceeds the estimation threshold, dynamically adjusting controller gains of the propulsion system to optimize the propulsion system for the payload estimation.

2. The method of claim 1, wherein the propulsion data includes one or more of:
current;
speed; or
torque.

3. The method of claim 1, wherein the payload estimation model is pre-trained in an offline training process.

4. The method of claim 1, wherein the offline training process pre-trains the payload estimation model to predict a payload given an input of propulsion data.

5. The method of claim 1, wherein the operations further comprise receiving a center of gravity of the vehicle transporting the product.

6. The method of claim 5, wherein dynamically adjusting the controller gains of the propulsion system to optimize the propulsion system for the payload estimation further comprises adapting constraints of the propulsion system based on the center of gravity of the vehicle transporting the product.

7. The method of claim 6, wherein the constraints of the propulsion system comprise one or more of:
acceleration;
deceleration; or
maximum speed.

8. The method of claim 1, wherein the operations further comprise, when the payload estimation does not exceed the estimation threshold, adjusting the controller gains of the propulsion system using nominal gains.

9. The method of claim 1, wherein detecting in real time, that the vehicle transporting the product is at the nominal speed comprises measuring the propulsion data at one of startup or acceleration of the propulsion system.

10. A system comprising:
data processing hardware; and
memory hardware in communication with the data processing hardware, the memory hardware storing instructions that when executed on the data processing hardware cause the data processing hardware to perform operations comprising:
detecting, in real time, that a vehicle transporting a product is at a nominal speed;
in response to detecting that the vehicle is at the nominal speed:
receiving propulsion data from a propulsion system of the vehicle;
based on the propulsion data, predicting, using a payload estimation model, a payload estimation of the product transported by the vehicle;
determining whether the payload estimation meets an estimation threshold; and
when the payload estimation exceeds the estimation threshold, dynamically adjusting controller gains of the propulsion system to optimize the propulsion system for the payload estimation.

11. The system of claim 10, wherein the propulsion data includes one or more of:
current;
speed; or
torque.

12. The system of claim 10, wherein the payload estimation model is pre-trained in an offline training process.

13. The system of claim 10, wherein the offline training process pre-trains the payload estimation model to predict a payload given an input set of propulsion data.

14. The system of claim 10, wherein the operations further comprise receiving a center of gravity of the vehicle transporting the product.

15. The system of claim 14, wherein dynamically adjusting the controller gains of the propulsion system to optimize the propulsion system for the payload estimation further comprises adapting constraints of the propulsion system based on the center of gravity of the vehicle transporting the product.

16. The system of claim 15, wherein the constraints of the propulsion system comprise one or more of:
acceleration;
deceleration; or
maximum speed.

17. The system of claim 10, wherein the operations further comprise, when the payload estimation does not exceed the estimation threshold, adjusting the controller gains of the propulsion system using nominal gains.

18. The system of claim 10, wherein detecting in real time, that the vehicle transporting the product is at the nominal speed comprises measuring the propulsion data at one of startup or acceleration of the propulsion system.

19. A computer-implemented method executing on data processing hardware that causes the data processing hardware to perform operations comprising:
detecting, in real time, that a propulsion system transporting a product is at a nominal speed;
in response to detecting that the propulsion system is at the nominal speed:
predicting, using a payload estimation model, a payload estimation of the product; and
when the payload estimation exceeds an estimation threshold, dynamically adjusting controller gains of the propulsion system to optimize the propulsion system for the product.

20. The method of claim 19, wherein dynamically adjusting the controller gains of the propulsion system to optimize the propulsion system for the product further comprises adapting constraints of the propulsion system based on a center of gravity of the product.
